(19) United States
(12) Patent Application Publication
(10) Pub. No.: US 2017/0374044 A1
(43) Pub. Date: Dec. 28, 2017

(54) MESSENGER APPLICATION SYSTEMS AND METHODS

(71) Applicant: Ahmed Hassan M ALYUBI, Lexington, KY (US)

(72) Inventor: Ahmed Hassan M ALYUBI, Lexington, KY (US)

(21) Appl. No.: 15/190,230

(22) Filed: Jun. 23, 2016

(51) Int. Cl. H04L 29/06; H04L 12/58

(52) U.S. Cl. CPC H04L 63/0485; H04L 63/06; H04L 51/04; H04L 51/32; H04L 63/0464

(57) ABSTRACT

A non-transitory computer-readable medium storing instructions which when executed by a computer of a first client device cause the computer to perform a method of communicating via a chat session is provided. The method includes receiving, a request from a first user to begin the chat session with a second user. When the requested chat session is designated as a secret chat, first user data encrypted using a first key for encrypting data to be decrypted by a second client device associated with the second user is transmitted to the second client device. When the requested chat session is not designated as the secret chat, the first user data encrypted using a second key for encrypting data to be decrypted by the server is transmitted to the server for forwarding to the second client device.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

### Description of the Related Art

Social networking has provided a mechanism in which a vast array of messaging and media can be posted and exchanged with other users. Texting, chatting, messaging, voice mail, images, videos, etc. can be posted to numerous social websites, which can be shared with another individual or the content can be made available to multiple audiences. However, there is a risk of uninvited parties intercepting a private exchange or viewing a private posting.

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly nor impliedly admitted as prior art against the described embodiments herein.

### SUMMARY

In one embodiment, a non-transitory computer-readable medium storing instructions which when executed by a computer of a first client device cause the computer to perform a method of communicating via a chat session. The method includes receiving a request from a first user to begin the chat session with a second user, and identifying first user data to be transmitted to the second user via a communication network. When the requested chat session is designated as a secret chat, the method includes encrypting, by circuitry of the first client device, the first user data using a first key for encrypting data to be decrypted by a second client device associated with the second user, the first key not being transmitted over the communication network, and transmitting the first user data encrypted using the first key to the second client device. When the requested chat session is not designated as the secret chat, the method includes encrypting, by the circuitry, the first user data using a second key for encrypting data to be decrypted by a server, and transmitting the first user data encrypted using the second key to the server for forwarding to the second client device, the first user data being decrypted and re-encrypted using a third key by the server. The method also includes receiving second user data from the second client device, decrypting the second user data encrypted by the second client device when the chat session is designated as the secret chat, and decrypting the second user data encrypted only by the server when the chat session is not designated as the secret chat. The method also includes outputting the second user data for display to the first user, and deleting the second user data when the chat session is designated as the secret chat to prevent subsequent display of the second user data.

In another embodiment, an information providing apparatus includes circuitry configured to receive, via a communication network, a request from a first user of a first client device to begin a chat session with a second user. When the requested chat session is designated as a secret chat, the circuitry is configured to receive, via the communication network, first user data encrypted using a first key for encrypting data to be decrypted by a second client device associated with the second user, the first key not being transmitted over the communication network, and send the first user data encrypted using the first key to the second client device, the first user data not being stored by the circuitry. When the requested chat session is designated as a secret chat, the circuitry is also configured to receive, via the communication network, second user data encrypted using a second key for encrypting data to be decrypted by the first client device, the second key not being transmitted over the communication network, and send the second user data encrypted using the second key to the first client device, the second user data not being stored by the circuitry. When the requested chat session is not designated as the secret chat, the circuitry is configured to receive, via the communication network, the first user data encrypted using a third key, decrypt the first user data encrypted using the third key, and store a copy of the decrypted first user data for subsequent access by the first or second user. When the requested chat session is not designated as the secret chat, the circuitry is also configured to encrypt the decrypted first user data using a fourth key, and send the first user data encrypted using the fourth key to the second client device. When the requested chat session is not designated as the secret chat, the circuitry is also configured to receive, via the communication network, the second user data encrypted using the fourth key, decrypt the second user data encrypted using the fourth key, and store a copy of the decrypted second user data for subsequent access by the first or second user. When the requested chat session is not designated as the secret chat, the circuitry is also configured to encrypt the decrypted second user data using the fourth key, and send the second user data encrypted using the fourth key to the first client device.

In another embodiment, a method of an information providing apparatus for providing a client session includes receiving, at the information providing apparatus via a communication network, a request from a first user of a first client device to begin the chat session with a second user. When the requested chat session is designated as a secret chat, the method includes receiving, via the communication network, first user data encrypted using a first key for encrypting data to be decrypted by a second client device associated with the second user, the first key not being transmitted over the communication network, and sending the first user data encrypted using the first key to the second client device, the first user data not being stored by circuitry of the information providing apparatus. When the requested chat session is designated as a secret chat, the method also includes receiving, via the communication network, second user data encrypted using a second key for encrypting data to be decrypted by the first client device, the second key not being transmitted over the communication network, and sending the second user data encrypted using the second key to the first client device, the second user data not being stored by circuitry of the information providing apparatus. When the requested chat session is not designated as the secret chat, the method includes receiving, via the communication network, the first user data encrypted using a third key, decrypting the first user data encrypted using the third key, and storing a copy of the decrypted first user data for subsequent access by the first or second user. When the requested chat session is not designated as the secret chat, the method includes encrypting the decrypted first user data using a fourth key, sending the first user data encrypted using the fourth key to the second client device, and receiving, via the communication network, the second user data encrypted using the fourth key. When the requested chat session is not designated as the secret chat, the method includes decrypting the second user data encrypted using the fourth key, storing a copy of the decrypted second user data for subsequent access by the first or second user, encrypting the decrypted second user data using the fourth key, and sending the second user data encrypted using the fourth key to the first client device.

In another embodiment, a computer-implemented method of providing a chat session between two or more user devices includes receiving at a server, via a mobile cryptographic protocol, a request from a first client to begin a chat session; and receiving a message encrypted by the first client transported over the mobile cryptographic protocol to the server. The method also includes encrypting the transported message by the server with a second encryption, wherein the first encryption differs from the second encryption; and delivering the transported message with the second encryption from the server to a second client. The method is implemented via communication circuitry configured to communicate through a server-to-client encryption layer via a saved session history when instructed in a server-to-client session, and communication through a client-to-client encryption layer via one or more independent request/response transactions when instructed in a direct client-to-client session, wherein the server cannot decrypt the transported message in the direct client-to-client session. The communication circuitry is also configured to erase data from the server and one or more databases at a predetermined time for the direct client-to-client session.

In another embodiment, a distributed mobile protocol messaging structure includes a server having processing circuitry configured for cloud storage of data, and communication circuitry. The communication circuitry is configured to communicate through a server-to-client₁ encryption layer via a saved session history when instructed in a server-to-client₁ session, and communicate through a server-to-client₂ encryption layer via the saved session history when instructed in a server-to-client₂ session. The communication circuitry is also configured to communicate through a client-to-client encryption layer via one or more independent request/response transactions when instructed in a client-to-client session, wherein the server cannot decrypt the client-to-client session conducted in the client-to-client encryption layer. The distributed mobile protocol messaging structure also includes two or more client devices, each having a password-protected session key and a data authorization key in an encrypted session via their respective server-to-client encryption layers and the client-to-client encryption layer. The distributed mobile protocol messaging structure also includes a timer configured to eliminate the client-to-client session from the two or more client devices at a conclusion of the client-to-client session.

In another embodiment, a computer-implemented method of encrypted messenger communication includes opening one or more connections to a server. The server has processing circuitry configured to communicate through a server-to-client encryption layer via a saved session history when instructed in a server-to-client session, communicate through a client-to-client encryption layer via one or more independent request/response transactions when instructed in a client-to-client session, and erase data from the server for the client-to-client session. The computer-implemented method also includes sending a message for the client-to-client session to the server via a transport layer over an existing network protocol, sending an indication for a timed self-destructed session from a first client to a second client, and receiving an open session at the first client with the second client via a password-protected session key and a data authorization key. Identifiers of most recent messages are received at the server, and the identifiers and session data of the client-to-client session are destroyed at the server after the indicated timed self-destructed session.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a distributed messaging structure according to one embodiment;

FIG. 2 is a block diagram illustrating an exemplary electronic device according to one embodiment;

FIG. 3 is a block diagram illustrating a computing system according to one embodiment;

FIG. 4 is a schematic diagram of a data processing system according to one embodiment;

FIG. 5 is a block diagram of a central processing unit (CPU) according to one embodiment;

FIG. 6 illustrates a cloud computing system according to one embodiment;

FIG. 7 is an exemplary algorithm for a computer-implemented method of providing a chat session according to one embodiment;

FIG. 8 is an exemplary algorithm for a computer-implemented method of encrypted messenger communication according to one embodiment;

FIG. 9 is an exemplary algorithmic flowchart from a terminal perspective of a method of communicating via a chat session according to one embodiment; and

FIGS. 10A-10B are an exemplary algorithmic flowchart for a method of an information providing apparatus for providing a chat session according to one embodiment.

### DETAILED DESCRIPTION

Embodiments herein describe messenger application systems and methods. A session is a semi-permanent interactive information interchange, which is also known as a dialogue, conversation, or meeting between two or more communicating devices, or between a computer and a user. A session is set up or established at a certain point in time and is torn down at some later point. An established communication session can involve more than one message in each direction.

In an example, a mobile messenger system has an end-to-end encryption between a receiver and a sender. No messaging is logged on to any associated messaging servers.

In another example, a distributed messaging infrastructure has sparsely spaced data centers and associated clusters of servers. Each server has circuitry configured for cloud storage of data. A password-protected session key and a data authorization key are stored on a client device.

In another example, a client-to-client chat encryption system has exchanged encryption keys between two or more devices, a direct client-to-client encryption layer, and an automatic elimination of chat content on the two or more devices after ending a chat session.

In another example, a Secure Sockets Layer (SSL) mobile protocol messenger system has a server-to-client encryption layer and a client-to-client encryption layer.

In another example, a method of encrypted messenger communication includes opening one or more connections to a server, and receiving any messages for a session that are present from the server. The method also includes receiving a dummy response from the server when no messages are present, and returning an acknowledgment response to the server. The method also includes storing identifiers of most recent messages received, and destroying identifiers after a pre-determined time of non-use.

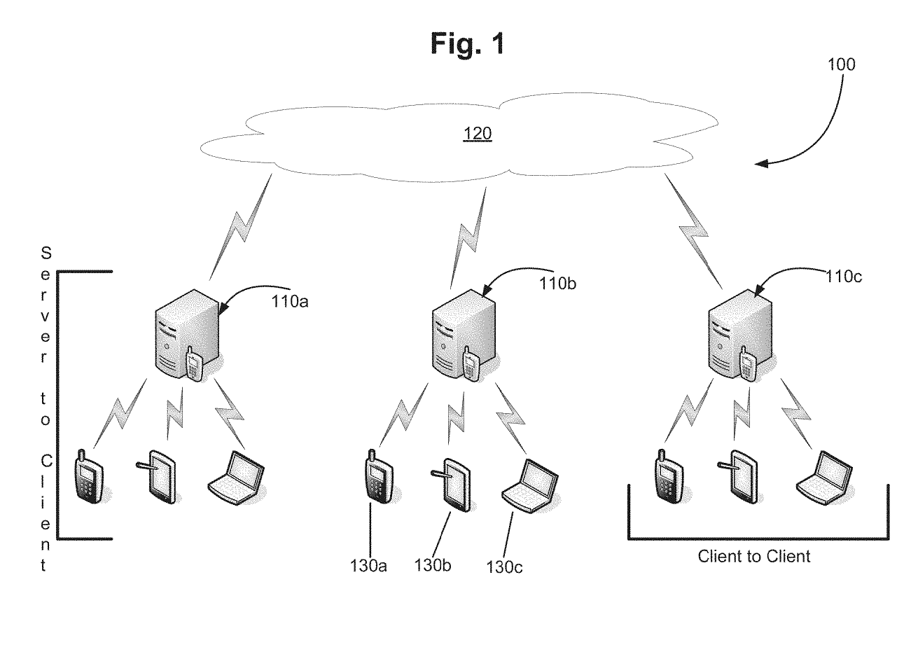

FIG. 1 illustrates a distributed messaging structure 100 in which multiple servers 110a-110c have processing and communication circuitry that is configured to communicate with a cloud structure 120. Cloud structure 120 provides an inter-networking between the servers 110a-110c through a combination of infrastructure, platforms, and applications, i.e. a combination of hardware and software, and circuitry configured to execute the software. Cloud structure 120 provides centralized data storage, as well as centralized access to computer services and resources. FIG. 1 illustrates just three servers 110a-110c for the sake of simplicity. However, hundreds or thousands of servers could be networked together in one or more clusters, which are controlled by a data center.

FIG. 1 also illustrates a number of user devices (e.g., 130a-130c). User devices 130a-130c are illustrated as portable devices that communicate with their respective server 110b through wireless communication. However, non-portable devices, such as a desktop terminal or another server with wired or wireless communication circuitry configurations are also contemplated by embodiments herein. Even though there are just three user devices illustrated for each of the servers 110a-110c, embodiments herein contemplate a vast array of user devices that each of the servers 110a-110c is equipped to accommodate.

FIG. 1 also illustrates that each of the servers 110a-110c has circuitry configurations for a server-to-client encryption layer and a client-to-client encryption layer. For the sake of simplicity, just one server-to-client encryption layer (illustrated in the left server of FIG. 1), and just one client-to-client encryption layer (illustrated in the right server of FIG. 1), are illustrated. However, each of the servers 110a-110c can have both encryption layers. This provides a dual purpose messenger system. In a server-to-client encryption layer, the associated user devices have all capabilities and advantages of cloud computing available. Photos, videos, messages, and files of any type can be forwarded to another client device and/or saved within the cloud structure 120 and still remain encryption protected.

A server-to-client session is a stateful session, meaning that at least one of the communicating parts needs to save information about the session history in order to be able to communicate. Communication transport can be implemented as part of protocols and services at the application layer, at the session layer, or at the transport layer.

If a transport protocol does not implement a formal session layer or where sessions at the application layer are generally short-lived, such as Hypertext Transport Protocol (HTTP), sessions are maintained by a higher level program using a method defined in the data being exchanged. In an example, an HTTP exchange between a browser and a remote host can include an HTTP cookie, also known as an HTTP session token, which identifies a state, such as a unique session ID, information about the user's preferences, or an authorization level.

Encryption protection is provided through a cryptographic protocol, such as Transport Layer Security (TLS), which is also known as Secure Sockets Layer (SSL). Other mobile protocols that provide encryption protection for accessing a server application program interface (API) from an application running on a device are contemplated by embodiments described herein.

In an embodiment, a mobile protocol includes a high-level component to define the method in which API queries and responses are converted to binary messages. The mobile protocol also includes a cryptographic layer to define the method by which messages are encrypted prior to being transmitted. A transport component of the mobile protocol defines the method for a client device and a server to transmit messages over another existing network protocol. Each plaintext message to be encrypted in SSL mobile protocol contains certain data to be checked upon decryption to protect the system. The data includes a server salt (i.e. random data used as additional input to a one-way function that hashes a password or passphrase), a session ID, a message sequence number, a message length, and/or a time component. In another embodiment, the API is open to developers; therefore, a custom application for other platforms can be developed.

In a high-level component, a client and a server exchange messages inside a session. The session is attached to the client device, i.e. the application rather than a specific connection. Each session is also attached to a user key ID by which authorization is accomplished.

Several connections to a server may be open, and messages may be sent in either direction through any of the connections. A response to a query is not necessarily returned through the same connection that carried the original query, although it usually is the same connection. However, a message cannot be returned through a connection belonging to a different session.

There are several types of messages. A Remote Procedure Call (RPC) is a client call to a server. An RPC response is a server call to a client, which is a result of an RPC call. A message received acknowledgment is a notification of the status of a set of messages from a message status query. A multipart message or container holds several messages, and can be used to send several RPC calls at once over an HTTP connection.

A message is a binary data stream, which can be aligned along a 4- or 16-byte boundary, for example. A first group of fields in the message are fixed and are used by the cryptographic and authorization system. Each message, either individual or inside a container, has a message identifier (for example, 64 bits), a message sequence number within a session (for example, 32 bits), a length of the message body in bytes (for example, 32 bits), and a body of any size (for example, a multiple of 4 bytes). When a container or a single message is sent, an internal header is added, the entire message is encrypted, and an external header is placed at the top of the message (for example, a 64-bit key identifier and a 128-bit message key). A message body can have a 32-bit message type, followed by type-dependent parameters. In particular, each RPC function can have a corresponding message type.

In the authorization and encryption, a message is encrypted and an external header is added at the top of the message prior to being transmitted over a network using a transport protocol. For example, a 64-bit key identifier that uniquely identifies an authorization key for the server as well as the user and a 128-bit message key can be used. The initial portion of the message to be encrypted contains variable data, such as session, message ID, sequence number, and server salt. The message key is defined as the 128 lower-order bits of a message body. Multipart messages can be encrypted as a single message.

A client application creates an authorization key, which can be generated when the application is first run, and usually remains the same. Certain measures can be taken to minimize messages being intercepted, which can subsequently be decrypted. Session keys can be generated using a Diffie-Hellman protocol, which can be used in conjunction with an authorization and message keys to select Advanced Encryption Standard (AES) parameters. After creating a new session, a client can send a special RPC query to the server to generate a session key. The server responds, after which all subsequent messages with the session are encrypted using the session key. The session key stored on the client device can be protected with a password, such as a text password. This password is not stored in memory in certain embodiments, and is entered by a user when starting the application or more frequently, depending upon the application settings. Data is cache-stored on the user device and can also be protected by encryption using an authorization key which is to be password-protected. A password is subsequently required to gain access, including access to the cache-stored data.

When a client time diverges widely from a server time, the server may start to ignore client messages or vice versa, due to an invalid message identifier, which is closely related to the creation time. When this occurs, the server can send the client a special message containing the correct time and a particular salt, such as a 128-bit salt, either explicitly provided by the client in a special RPC synchronization request or an equivalent to the key of the latest message received from the client during the current session. The message can be the first message in a container which includes other messages, if the time discrepancy is significant but does not yet result in the client's messages being ignored. When the client receives such a message or a container with such a message, the client can perform a time synchronization by simply storing the difference between the server's time and the client's time to be able to compute the correct time in the future, and then verify the message identifiers for correctness. When a time correction is neglected, the client will need to generate a new session to assure the monotonicity of message identifiers.

There are multiple modes of transport, which enable delivery of encrypted containers together with an external header from the client to the server and back again. Types of transport include, but are not limited to HTTP, Transmission Control Protocol (TCP), and User Datagram Protocol (UDP).

An HTTP connection is attached to a session or a session plus a key identifier specified in the most recent user query received. When a session is the same in all queries, it can be corrupted. A server may not return a message into an HTTP connection unless it belongs to the same session and unless it is the server's turn, i.e. an HTTP request had been received from the client in which a response has not been sent yet.

A client can open one or more Keepalive HTTP connections to the server. If one or more messages need to be sent, they can be made into a payload, which is followed by a POST request to the URL/API to which the payload is transmitted as data. Content-Length, Keepalive, and Host can be used as valid HTTP headers.

After receiving the query, the server can either wait if the query requires a response following a short timeout, or the server can immediately return a dummy response to acknowledge receipt of the container. In either case, the response may contain any number of messages. The server can send out any other messages it might be holding for the session at the same time.

A long poll RPC query can transmit a maximum timeout T, which is only valid for HTTP connections. If the server has messages for a session, they can be returned immediately. Otherwise, a wait state is entered until such time as the server has a message for the client or T seconds have elapsed. If no events occur in the span of T seconds, a dummy response is returned.

If a server needs to send a message to a client, it checks for an HTTP connection that belongs to the required session and is in an answering HTTP request state, including a long poll. The message is added to the response container for the connection and sent to the user. If no suitable HTTP connection is available, the messages are placed in the current session's send queue. The messages may also be placed in the current session's send queue until receipt is explicitly or indirectly confirmed by the client. For an HTTP protocol, sending the next query into the same HTTP connection can be regarded as an implicit or explicit acknowledgment. The client may be required to return an explicit acknowledgment within a reasonable time, which can be added to a container for the following request.

If the acknowledgment fails to arrive on time, the message can be resent, possibly in a different container. The parties need to be autonomously ready for this to store the identifiers of the most recent messages received, and ignore such duplicates rather than repeat an action. In order to avoid storing the identifiers forever, a garbage collection message can be used to take advantage of message identifier monotonicity.

TCP transport is similar to HTTP transport. TCP can be implemented and can use the same server IP addresses as HTTP transport. The server understands whether HTTP or TCP protocol is used for the connection based on the first four incoming bytes.

When a TCP connection is created, it is assigned to the session with an associated authorization key and transmitted in the first user message. It is subsequently used exclusively for this session. As a result, multiplexing arrangements are not allowed.

If a payload, i.e. packet needs to be transmitted from a server to a client, or from the client to the server, it can be encapsulated according to the following example. Four length bytes can be added at the front, which include the length, the sequence number, and CRC32. Four bytes can be added with the packet sequence number within the TCP connection, Four CRC32 bytes can be added at the end for the length, sequence number and the payload together. Other encapsulation arrangements are contemplated by embodiments described herein.

There are no implicit acknowledgments for TCP transport; all messages are acknowledged explicitly. Acknowledgments can be placed in a container with the next query or response if it is transmitted in short order. For example, this may be the case for client messages containing RPC queries, where the acknowledgment arrives with the RPC response.

In a client-to-client encryption layer, the encryption protection described above for the server-to-client encryption layer is also available at the client-to-client encryption layer. In addition, the client-to-client encryption layer provides a direct end-to-end encryption. As a result, two or more user devices can communicate directly to ensure that a message can only be read by its intended recipient. One embodiment of utilizing an end-to-end encryption layer is in a chat session with two or more user devices 130a-130c. However, other messenger communications can use an end-to-end encryption layer for maximum security. In this embodiment, none of the messenger sessions are logged onto their associated server 110b. The content of the session can only be found on the session user devices. In addition, a timer can be utilized to erase all contents of the session from the user devices at the conclusion of the session.

A client-to-client session utilizes a stateless protocol, which is a communications protocol that treats each request as an independent transaction that is unrelated to any previous request. The communication includes independent pairs of a request and response. A stateless protocol does not require the server to retain session information or status about each communications partner for the duration of multiple requests. Examples of stateless protocols include the Internet Protocol (IP), which is the foundation for the Internet and HTTP, which is the foundation of data communication for the World Wide Web.

A client-to-client session can also be implemented via a tunneling protocol, which encapsulates a variety of network layer protocols inside a virtual point-to-point link over an Internet Protocol network. In an example, a Point-to-Point Tunneling Protocol (PPTP) can be utilized for a client-to-client session. A client-to-client session can include HTTP and Short Messaging Service (SMS).

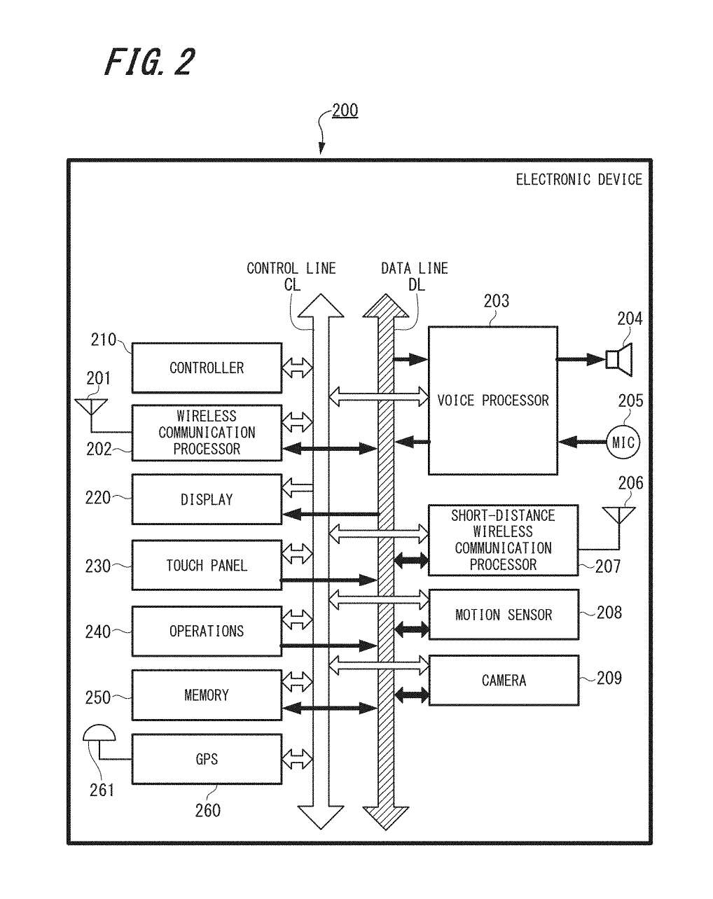

FIG. 2 is a block diagram illustrating an exemplary electronic device used in accordance with certain embodiments of the present disclosure, such as user devices. In certain embodiments, electronic device 200 can be a smartphone, a laptop, a tablet, a server, an e-reader, a camera, a navigation device, etc. The exemplary electronic device 200 of FIG. 2 includes a controller 210 and a wireless communication processor 202 connected to an antenna 201. A speaker 204 and a microphone 205 are connected to a voice processor 203.

The controller 210 can include one or more CPUs, and can control each element in the electronic device 200 to perform functions related to communication control, audio signal processing, control for the audio signal processing, still and moving image processing and control, and other kinds of signal processing. The controller 210 can perform these functions by executing instructions stored in a memory 250. Alternatively or in addition to the local storage of the memory 250, the functions can be executed using instructions stored on an external device accessed on a network or on a non-transitory computer readable medium.

The memory 250 includes but is not limited to Read Only Memory (ROM), Random Access Memory (RAM), or a memory array including a combination of volatile and non-volatile memory units. The memory 250 can be utilized as working memory by the controller 210 while executing the processes and algorithms of the present disclosure. Additionally, the memory 250 can be used for long-term storage, e.g., of image data and information related thereto.

The electronic device 200 includes a control line CL and data line DL as internal communication bus lines. Control data to/from the controller 210 can be transmitted through the control line CL. The data line DL can be used for transmission of voice data, display data, etc.

The antenna 201 transmits/receives electromagnetic wave signals between base stations for performing radio-based communication, such as the various forms of cellular telephone communication. The wireless communication processor 202 controls the communication performed between the electronic device 200 and other external devices via the antenna 201. For example, the wireless communication processor 202 can control communication between base stations for cellular phone communication.

The speaker 204 emits an audio signal corresponding to audio data supplied from the voice processor 203. The microphone 205 detects surrounding audio and converts the detected audio into an audio signal. The audio signal can then be output to the voice processor 203 for further processing. The voice processor 203 demodulates and/or decodes the audio data read from the memory 250 or audio data received by the wireless communication processor 202 and/or a short-distance wireless communication processor 207. Additionally, the voice processor 203 can decode audio signals obtained by the microphone 205.

The exemplary electronic device 200 can also include a display 220, a touch panel 230, an operations key 240, and a short-distance communication processor 207 connected to an antenna 206. The display 220 can be a Liquid Crystal Display (LCD), an organic electroluminescence display panel, or another display screen technology. In addition to displaying still and moving image data, the display 220 can display operational inputs, such as numbers or icons which can be used for control of the electronic device 200. The display 220 can additionally display a GUI for a user to control aspects of the electronic device 200 and/or other devices. Further, the display 220 can display characters and images received by the electronic device 200 and/or stored in the memory 250 or accessed from an external device on a network. For example, the electronic device 200 can access a network such as the Internet and display text and/or images transmitted from a Web server.

The touch panel 230 can include a physical touch panel display screen and a touch panel driver. The touch panel 230 can include one or more touch sensors for detecting an input operation on an operation surface of the touch panel display screen. The touch panel 230 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus such that the sensors included in the touch panel 230 can detect when the stylus approaches/contacts the operation surface of the touch panel display (similar to the case in which a finger is used for the touch operation).

In certain aspects of the present disclosure, the touch panel 230 can be disposed adjacent to the display 220 (e.g., laminated) or can be formed integrally with the display 220. For simplicity, the present disclosure assumes the touch panel 230 is formed integrally with the display 220 and therefore, examples discussed herein can describe touch operations being performed on the surface of the display 220 rather than the touch panel 230. However, the skilled artisan will appreciate that this is not limiting.

For simplicity, the present disclosure assumes the touch panel 230 is a capacitance-type touch panel technology. However, it should be appreciated that aspects of the present disclosure can easily be applied to other touch panel types (e.g., resistance-type touch panels) with alternate structures. In certain aspects of the present disclosure, the touch panel 230 can include transparent electrode touch sensors arranged in the X-Y direction on the surface of transparent sensor glass.

The touch panel driver can be included in the touch panel 230 for control processing related to the touch panel 230, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 230 and the display 220 can be surrounded by a protective casing, which can also enclose the other elements included in the electronic device 200. In certain embodiments, a position of the user's fingers on the protective casing (but not directly on the surface of the display 220) can be detected by the touch panel 230 sensors. Accordingly, the controller 210 can perform display control processing described herein based on the detected position of the user's fingers gripping the casing. For example, an element in an interface can be moved to a new location within the interface (e.g., closer to one or more of the fingers) based on the detected finger position.

Further, in certain embodiments, the controller 210 can be configured to detect which hand is holding the electronic device 200, based on the detected finger position. For example, the touch panel 230 sensors can detect a plurality of fingers on the left side of the electronic device 200 (e.g., on an edge of the display 220 or on the protective casing), and detect a single finger on the right side of the electronic device 200. In this exemplary scenario, the controller 210 can determine that the user is holding the electronic device 200 with his/her right hand because the detected grip pattern corresponds to an expected pattern when the electronic device 200 is held only with the right hand.

The operation key 240 can include one or more buttons or similar external control elements, which can generate an operation signal based on a detected input by the user. In addition to outputs from the touch panel 230, these operation signals can be supplied to the controller 210 for performing related processing and control. In certain aspects of the present disclosure, the processing and/or functions associated with external buttons and the like can be performed by the controller 210 in response to an input operation on the touch panel 230 display screen rather than the external button, key, etc. In this way, external buttons on the electronic device 200 can be eliminated in lieu of performing inputs via touch operations, thereby improving water-tightness.

The antenna 206 can transmit/receive electromagnetic wave signals to/from other external apparatuses, and the short-distance wireless communication processor 207 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 207.

The electronic device 200 can include a motion sensor 208. The motion sensor 208 can detect features of motion (i.e., one or more movements) of the electronic device 200. For example, the motion sensor 208 can include an accelerometer to detect acceleration, a gyroscope to detect angular velocity, a geomagnetic sensor to detect direction, a geo-location sensor to detect location, etc., or a combination thereof to detect motion of the electronic device 200. In certain embodiments, the motion sensor 208 can generate a detection signal that includes data representing the detected motion. For example, the motion sensor 208 can determine a number of distinct movements in a motion (e.g., from start of the series of movements to the stop, within a predetermined time interval, etc.), a number of physical shocks on the electronic device 200 (e.g., a jarring, hitting, etc., of the electronic device 200), a speed and/or acceleration of the motion (instantaneous and/or temporal), or other motion features. The detected motion features can be included in the generated detection signal. The detection signal can be transmitted, e.g., to the controller 210, whereby further processing can be performed based on data included in the detection signal. The motion sensor 208 can work in conjunction with a Global Positioning System (GPS) 260. The GPS 260 detects the present position of the electronic device 200. The information of the present position detected by the GPS 260 is transmitted to the controller 210. An antenna 261 is connected to the GPS 260 for receiving and transmitting signals to and from a GPS satellite.

Electronic device 200 can include a camera 209, which includes a lens and shutter for capturing photographs of the surroundings around the electronic device 200. In an embodiment, the camera 209 captures surroundings of an opposite side of the electronic device 200 from the user. The images of the captured photographs can be displayed on the display panel 220. A memory saves the captured photographs. The memory can reside within the camera 209 or it can be part of the memory 250. The camera 209 can be a separate feature attached to the electronic device 200 or it can be a built-in camera feature.

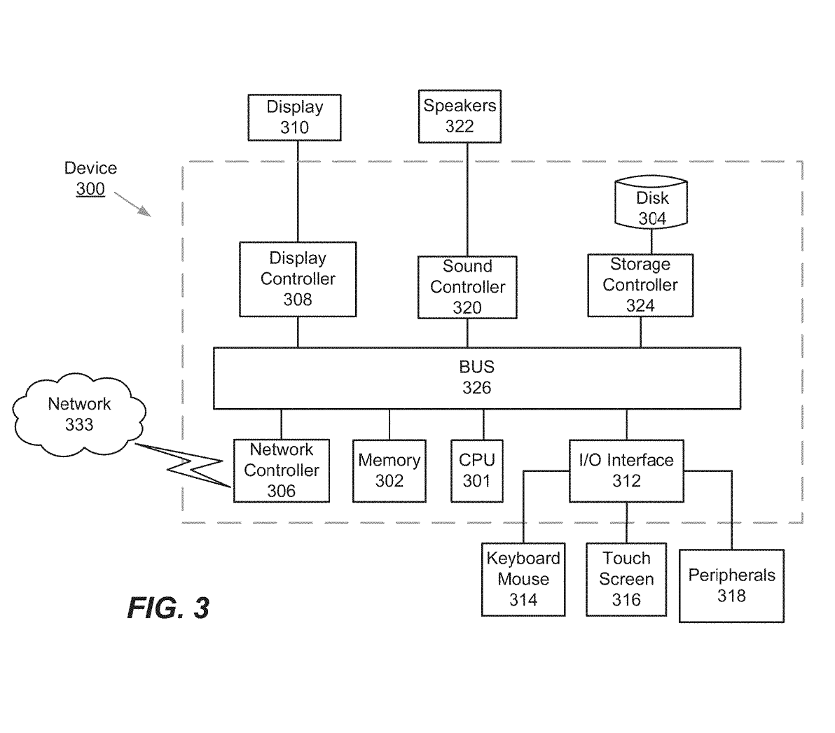

Next, a hardware description of a computing device 300 according to exemplary embodiments is described with reference to FIG. 3, such as servers 110a-110c. Certain features described above with reference to electronic device 200 of FIG. 2 can be included in the computing device 300 described below. Exemplary embodiments described herein can be implemented on either electronic device 200 or computing device 300.

In FIG. 3, the computing device 300 includes a CPU 301 which performs the processes described above and herein after. The process data and instructions can be stored in memory 302. These processes and instructions can also be stored on a storage medium disk 304 such as a hard drive (HDD) or portable storage medium or can be stored remotely. Further, the claimed features are not limited by the form of the computer-readable media on which the instructions of the process are stored. For example, the instructions can be stored on CDs, DVDs, in FLASH memory, RAM, ROM, PROM, EPROM, EEPROM, hard disk or any other information processing device with which the computing device 300 communicates, such as a server or computer.

Further, the claimed features can be provided as a utility application, background daemon, or component of an operating system, or combination thereof, executing in conjunction with CPU 301 and an operating system such as Microsoft Windows, UNIX, Solaris, LINUX, Apple MAC-OS and other systems known to those skilled in the art.

The hardware elements in order to achieve the computing device 300 can be realized by various circuitry elements, known to those skilled in the art. For example, CPU 301 can be a Xenon or Core processor from Intel of America or an Opteron processor from AMD of America, or can be other processor types that would be recognized by one of ordinary skill in the art. Alternatively, the CPU 301 can be implemented on an FPGA, ASIC, PLD or using discrete logic circuits, as one of ordinary skill in the art would recognize. Further, CPU 301 can be implemented as multiple processors cooperatively working in parallel to perform the instructions of the inventive processes described above and below.

The computing device 300 in FIG. 3 also includes a network controller 306, such as an Intel Ethernet PRO network interface card from Intel Corporation of America, for interfacing with network 333. As can be appreciated, the network 333 can be a public network, such as the Internet, or a private network such as an LAN or WAN network, or any combination thereof and can also include PSTN or ISDN sub-networks. The network 333 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 300 further includes a display controller 308, such as a NVIDIA GeForce GTX or Quadro graphics adaptor from NVIDIA Corporation of America for interfacing with display 310, such as a Hewlett Packard HPL2445w LCD monitor. A general purpose I/O interface 312 interfaces with a keyboard and/or mouse 314 as well as a touch screen panel 316 on or separate from display 310. Touch screen panel 316 includes features described above with reference to touch panel 230 of FIG. 2. General purpose I/O interface 312 also connects to a variety of peripherals 318 including printers and scanners, such as an OFFICEJET or DESKJET from Hewlett Packard.

A sound controller 320 is also provided in the computing device 300, such as SOUNDBLASTER X-FI TITANIUM from Creative, to interface with speakers/microphone 322 thereby providing and/or receiving sounds and/or music.

The general purpose storage controller 324 connects the storage medium disk 304 with communication bus 326, which can be an ISA, EISA, VESA, PCI, or similar, for interconnecting all of the components of the computing device 300.

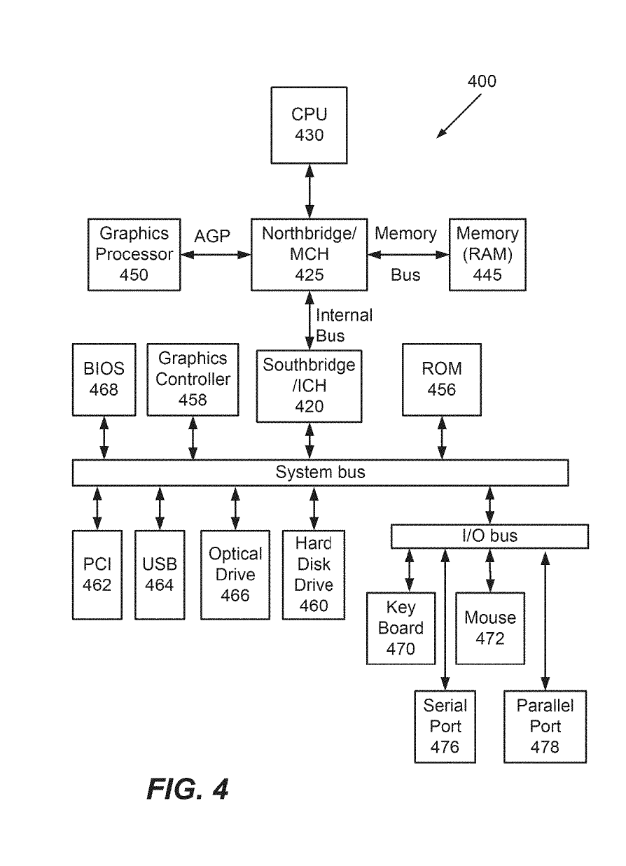

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown on FIG. 4. The chipset of FIG. 4 can be implemented in conjunction with either electronic device 200 or computing device 300 described above with reference to FIGS. 2 and 3, respectively.

FIG. 4 shows a schematic diagram of a data processing system, according to certain embodiments. The data processing system is an example of a computer in which code or instructions implementing the processes of the illustrative embodiments can be located.

In FIG. 4, data processing system 400 employs an application architecture including a north bridge and memory controller application (NB/MCH) 425 and a south bridge and input/output (I/O) controller application (SB/ICH) 420. The central processing unit (CPU) 430 is connected to NB/MCH 425. The NB/MCH 425 also connects to the memory 445 via a memory bus, and connects to the graphics processor 450 via an accelerated graphics port (AGP). The NB/MCH 425 also connects to the SB/ICH 420 via an internal bus (e.g., a unified media interface or a direct media interface). The CPU 430 can contain one or more processors and even can be implemented using one or more heterogeneous processor systems.

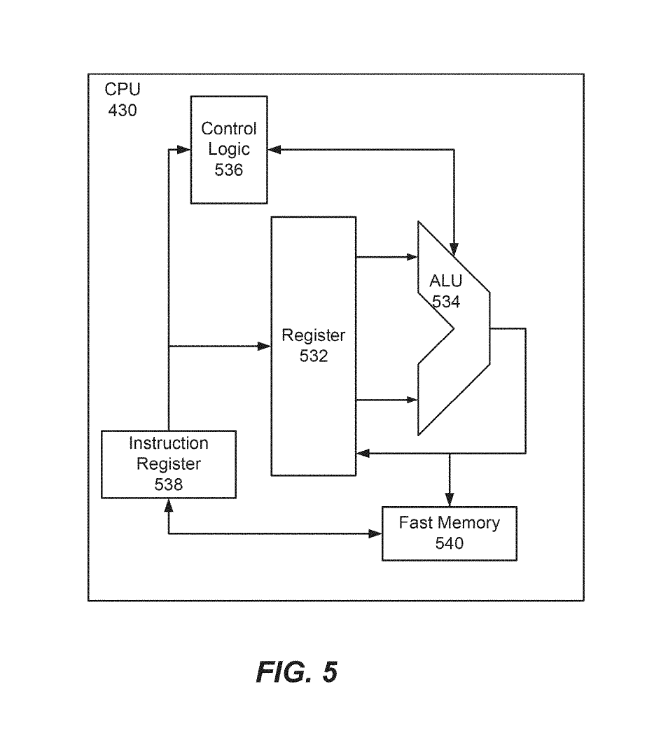

For example, FIG. 5 shows one implementation of CPU 430. In one implementation, an instruction register 538 retrieves instructions from a fast memory 540. At least part of these instructions are fetched from an instruction register 538 by a control logic 536 and interpreted according to the instruction set architecture of the CPU 430. Part of the instructions can also be directed to a register 532. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 534 that loads values from the register 532 and performs logical and mathematical operations on the loaded values according to the instructions. The results from these operations can be fed back into the register 532 and/or stored in a fast memory 540. According to certain implementations, the instruction set architecture of the CPU 430 can use a reduced instruction set architecture, a complex instruction set architecture, a vector processor architecture, or a very large instruction word architecture. Furthermore, the CPU 430 can be based on the Von Neuman model or the Harvard model. The CPU 430 can be a digital signal processor, an FPGA, an ASIC, a PLA, a PLD, or a CPLD. Further, the CPU 430 can be an x86 processor by Intel or by AMD; an ARM processor; a POWER architecture processor by, e.g., IBM; a SPARC architecture processor by Sun Microsystems or by Oracle; or other known CPU architectures.

Referring again to FIG. 4, the data processing system 400 can include the SB/ICH 420 being coupled through a system bus to an I/O Bus, a read only memory (ROM) 456, universal serial bus (USB) port 464, a flash binary input/output system (BIOS) 468, and a graphics controller 458. PCI/PCIe devices can also be coupled to SB/ICH 420 through a PCI bus 462.

The PCI devices can include, for example, Ethernet adapters, add-in cards, and PC cards for notebook computers. The Hard disk drive 460 and CD-ROM 466 can use, for example, an integrated drive electronics (IDE) or serial advanced technology attachment (SATA) interface. In one implementation the I/O bus can include a super I/O (SIO) device.

Further, the hard disk drive (HDD) 460 and optical drive 466 can also be coupled to the SB/ICH 420 through a system bus. In one implementation, a keyboard 470, a mouse 472, a parallel port 478, and a serial port 476 can be connected to the system bus through the I/O bus. Other peripherals and devices can be connected to the SB/ICH 420 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

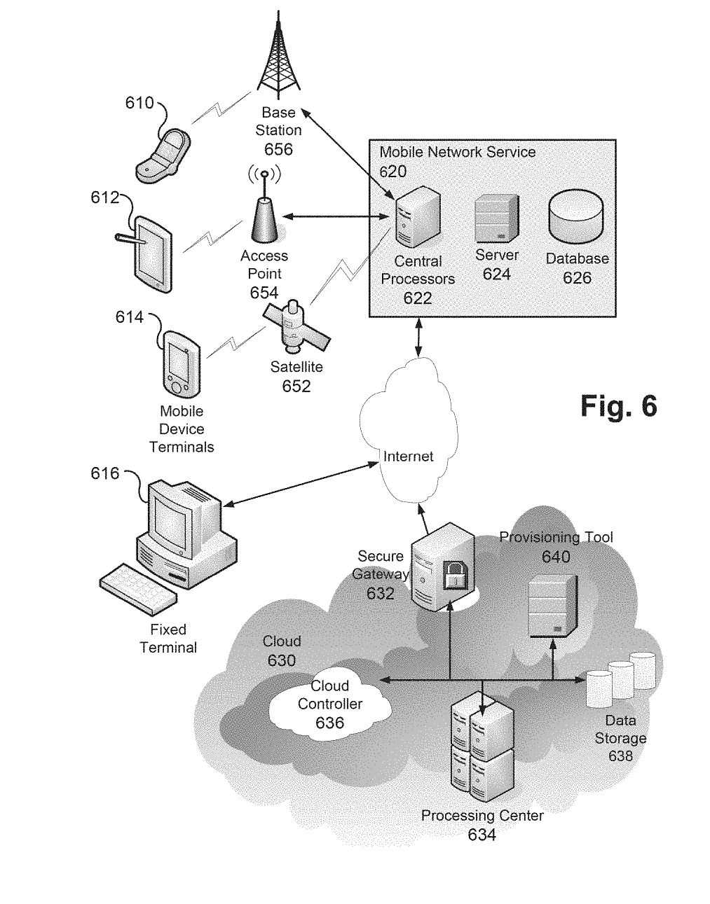

FIG. 6 illustrates an example of a cloud computing system, such as cloud structure 120, wherein users access the cloud through mobile device terminals or fixed terminals that are connected to the Internet. The mobile device terminals can include a cell phone 610, a tablet computer 612, and a smartphone 614, for example. The mobile device terminals can connect to a mobile network service 620 through a wireless channel such as a base station 656 (e.g., an Edge, 3G, 4G, or LTE Network), an access point 654 (e.g., a femto cell or WiFi network), or a satellite connection 652. In one implementation, signals from the wireless interface to the mobile device terminals (e.g., the base station 656, the access point 654, and the satellite connection 652) are transmitted to a mobile network service 620, such as an EnodeB and radio network controller, UMTS, or HSDPA/HSUPA. Mobile users' requests and information are transmitted to central processors 622 that are connected to servers 624 to provide mobile network services, for example. Further, mobile network operators can provide service to mobile users for authentication, authorization, and accounting based on home agent and subscribers' data stored in databases 626, for example. The subscribers' requests are subsequently delivered to a cloud 630 through the Internet.

A user can also access the cloud through a fixed terminal 616, such as a desktop or laptop computer or workstation that is connected to the Internet via a wired network connection or a wireless network connection. The mobile network service 620 can be a public or a private network such as an LAN or WAN network. The mobile network service 620 can be wireless such as a cellular network including EDGE, 3G and 4G wireless cellular systems. The wireless mobile network service 620 can also be Wi-Fi, Bluetooth, or any other wireless form of communication.

The user's terminal, such as a mobile user terminal or a fixed user terminal, provides a mechanism to connect via the Internet to the cloud 630 and to receive output from the cloud 630, which is communicated and displayed at the user's terminal. In the cloud 630, a cloud controller 636 processes the request to provide users with the corresponding cloud services. These services are provided using the concepts of utility computing, virtualization, and service-oriented architecture.

In one implementation, the cloud 630 is accessed via a user interface such as a secure gateway 632. The secure gateway 632 can for example, provide security policy enforcement points placed between cloud service consumers and cloud service providers to interject enterprise security policies as the cloud-based resources are accessed. Further, the secure gateway 632 can consolidate multiple types of security policy enforcement, including for example, authentication, single sign-on, authorization, security token mapping, encryption, tokenization, logging, alerting, and API control.

The cloud 630 can provide to users, computational resources using a system of virtualization, wherein processing and memory requirements can be dynamically allocated and dispersed among a combination of processors and memories to create a virtual machine that is more efficient at utilizing available resources. Virtualization creates an appearance of using a single seamless computer, even though multiple computational resources and memories can be utilized according to increases or decreases in demand. In one implementation, virtualization is achieved using a provisioning tool 640 that prepares and equips the cloud resources, such as the processing center 634 and data storage 638 to provide services to the users of the cloud 630. The processing center 634 can be a computer cluster, a data center, a main frame computer, or a server farm. In one implementation, the processing center 634 and data storage 638 are collocated.

Embodiments described herein can be implemented in conjunction with one or more of the devices described above with reference to FIGS. 2-6. Embodiments are a combination of hardware and software, and processing and communications circuitry by which the software is implemented.

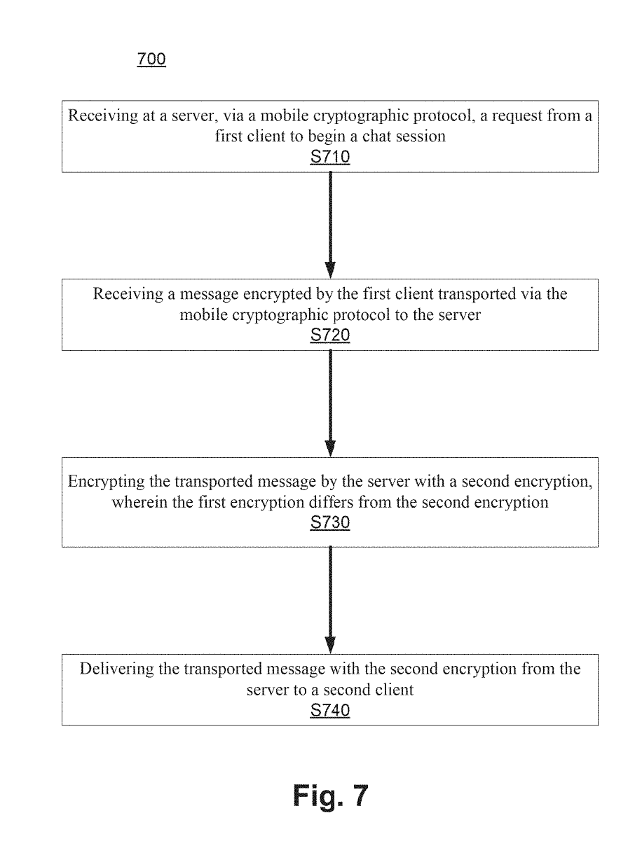

FIG. 7 illustrates an exemplary algorithmic flowchart for a computer-implemented method 700 of providing a chat session between two or more user devices according to an aspect of the present disclosure. Computer-implemented method 700 includes programmable computer-executable instructions, that when used in combination with the above-described distributed messaging structure 100 and the above-described hardware devices, carry out the steps of computer-implemented method 700. The hardware description above, exemplified by any one of the structural examples illustrated in FIG. 2, 3, or 4 constitutes or includes specialized corresponding circuitry that is programmed or configured to perform the algorithm illustrated in FIG. 7. For example, the algorithm illustrated in FIG. 7 can be completely performed by the single device illustrated in FIG. 2 or FIG. 3, or the chipset illustrated in FIG. 4. The algorithm can also be completely performed in a shared manner distributed over the circuitry of a plurality of devices in a cloud computing system, such as the cloud computing system of FIG. 6.

A client-to-server encryption is a connection from a client to a server that prevents third parties from viewing or sniffing what was sent by the client. When the message reaches the server, it is sent unencrypted to the recipient client, unless the recipient client is also using an encrypted link to the server. This can occur through Transport Layer Security or other similar security layer.

A client-to-client encryption is a message encrypted by a first client for a recipient client in which only the recipient client can view it. The server is not able to decrypt it and can only forward the encrypted message. Only the recipient client can decrypt the message. Similarly encrypted messages can also be sent from the second (recipient) client back to the first client. A direct client-to-client encryption can be transmitted through Transport Layer Security or other similar security layer.

In a client-to-client encryption for embodiments described herein, a first client can send a message to a server (such as an introductory “hello” message) using a first encryption code. A second encryption code, which differs from the first encryption code is used to transport the message from the server to a second client. The server has software and associated circuitry configured to erase data from the server according to a set time or according to a regular schedule, such as every thirty minutes.

Each server can operate within a generic routing encapsulation, wherein nothing is logged onto the server. Generic routing encapsulation is a tunneling protocol that can encapsulate a wide variety of network layer protocols inside a virtual point-to-point link over an Internet protocol network. A packet header is used to properly route the message. An example of a generic routing encapsulation is SoftLayer. However, other forms of generic routing encapsulation can be used with embodiments described herein.

In a client-to-client encryption, a self-destruct timer with a desired time limit can be set by a first client. The timer can be attached to a message sent by the first client to a second client. The timer begins counting when the timer is displayed to the second client. When time expires, all messages disappear from both clients.

As described above, FIG. 7 is an exemplary algorithm for a computer-implemented method 700 of providing a chat session between two or more user devices. Step S710 includes receiving at a server, via a mobile cryptographic protocol, a request from a first client to begin a chat session. An example of a mobile cryptographic protocol is Point-to-Point Tunneling Protocol (PPTP). Another example of a mobile cryptographic protocol is Authentication and Key Agreement (AKA) Protocol. However, other mobile cryptographic protocols can be used with embodiments described herein.

Step S720 includes receiving a message encrypted by the first client and transported via the mobile cryptographic protocol at the server. In step S730, the transported message is optionally encrypted by the server with a second encryption, wherein the first encryption differs from the second encryption. In step S740, the transported message with the second encryption is delivered from the server to a second client. In another embodiment, the server simply forwards the encrypted message.

In one embodiment, the computer-implemented method 700 is implemented via circuitry configured to communicate through a server-to-client encryption layer, via a saved session history when instructed in a server-to-client session, and to communicate through a client-to-client encryption layer, via one or more independent request/response transactions when instructed in a direct client-to-client session. The server cannot decrypt the transported message in the direct client-to-client session. The communication circuitry is further configured to erase data from the server and one or more databases at a predetermined time for the direct client-to-client session.

In some embodiments, the server-to-client encryption layer utilizes a cloud infrastructure. In other embodiments, the client-to-client encryption layer utilizes a direct first client end to a second client end. The chat session of the client-to-client encryption layer is not stored in the server. In a further embodiment, the chat session is removed from the first client and the second client after the predetermined time. In another embodiment, the chat session of the client-to-client encryption layer cannot be forwarded to another client. In another embodiment, the direct client-to-client session includes one of HTTP and SMS. In yet another embodiment, the direct client-to-client session is implemented via PPTP.

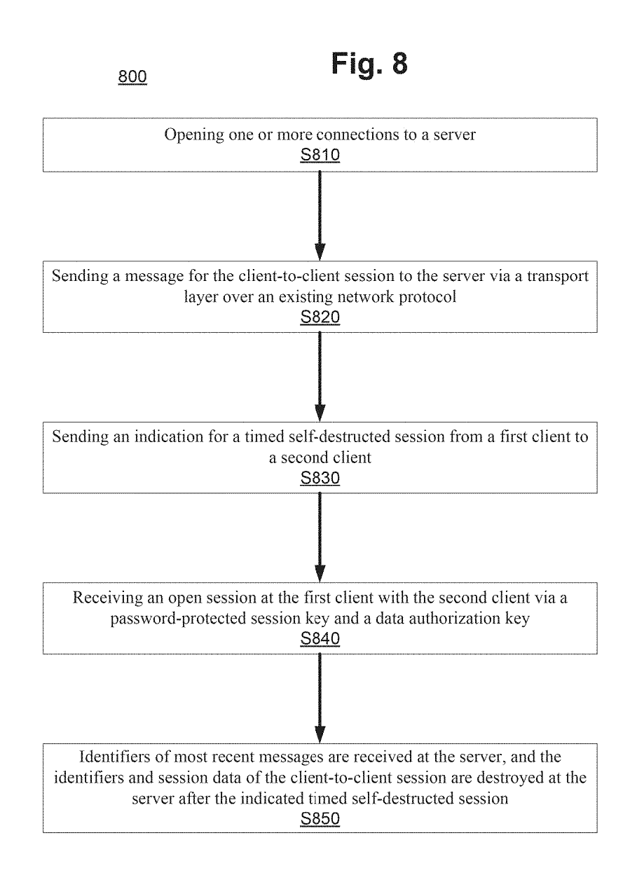

FIGS. 8, 9, and 10A-10B illustrate exemplary algorithmic flowcharts of encrypted messenger communication according to aspects of the present disclosure. Computer-implemented methods 800, 900, and 1100, as well as the information providing apparatus 1000 include programmable computer-executable instructions, that when used in combination with the above-described distributed messaging structure 100 and the above-described hardware devices, carry out the steps of computer-implemented methods 800, 900, and 1000. The hardware description above, exemplified by any one of the structural examples illustrated in FIG. 2, 3, or 4 constitutes or includes specialized corresponding circuitry that is programmed or configured to perform the algorithms illustrated in FIGS. 8, 9, and 10A-10B. For example, the algorithms illustrated in FIGS. 8, 9, and 10A-10B can be completely performed by the single device illustrated in FIG. 2 or FIG. 3, or the chipset illustrated in FIG. 4. The algorithms can also be completely performed in a shared manner distributed over the circuitry of a plurality of devices in a cloud computing system, such as the cloud computing system of FIG. 6.

As described above, FIG. 8 is an exemplary flow diagram for a computer-implemented method 800 of encrypted messenger communication. In step S810, the computer-implemented method 800 includes opening one or more connections to a server. In step S820, the computer-implemented method 800 also includes sending a message for the client-to-client session to the server, via a transport layer over an existing network protocol. In step S830, an indication for a timed self-destructed session is sent from a first client to a second client. In step S840, an open session is received at the first client with the second client via a password-protected session key and a data authorization key. In step S850, identifiers of most recent messages are received at the server. The identifiers and session data of the client-to-client session are destroyed at the server after the indicated timed self-destructed session.

In one embodiment, the computer-implemented method 800 is implemented via circuitry configured to communicate through a server-to-client encryption layer via a saved session history when instructed in a server-to-client session, communicate through a client-to-client encryption layer via one or more independent request/response transactions when instructed in a client-to-client session, and erase data from the server for the client-to-client session.

In some embodiments, the client-to-client session includes one of HTTP, HTTPS, TCP, or UDP. In another embodiment, the mobile protocol is SSL mobile protocol. The client-to-client session can include one of HTTP and SMS. The client-to-client session can be implemented via a PPTP.

A distributed mobile protocol messaging structure includes a server having processing circuitry configured for cloud storage of data, and communication circuitry. The communication circuitry is configured to communicate through a server-to-client₁ encryption layer via a saved session history when instructed in a server-to-client₁ session, communicate through a server-to-client₂ encryption layer via the saved session history when instructed in a server-to-client₂ session, and communicate through a client-to-client encryption layer via one or more independent request/response transactions when instructed in a client-to-client session, wherein the server cannot decrypt the client-to-client session conducted in the client-to-client encryption layer. The distributed mobile protocol messaging structure also includes two or more client devices, each having a password-protected session key and a data authorization key in an encrypted session via their respective server-to-client encryption layers and the client-to-client encryption layer, and a timer configured to eliminate the client-to-client session from the two or more client devices at a conclusion of the client-to-client session.

The client-to-client session of the distributed mobile protocol messaging structure can include one of HTTP and SMS. The client-to-client session can also be implemented via a PPTP.

The distributed mobile protocol messaging structure can also include the timer automatically eliminating the client-to-client session when communicating in the client-to-client encryption layer, and the client-to-client session is not saved within the cloud storage. The server-to-client₁ session and the server-to-client₂ session are stored in the cloud storage when communicating in the server-to-client encryption layer or the server-to-client₂ encryption layer, respectively.

The distributed mobile protocol messaging structure can also include a transport layer having communication circuitry configured to send and receive communications between the server and the two or more client devices over an existing network protocol. The distributed mobile protocol messaging structure can also include a distributed data center infrastructure configured to interconnect multiple servers, wherein the two or more client devices each connect to a closest server.

Embodiments described herein for messenger application systems and methods combine the attributes and advantages of texting and email for portable and non-portable user devices. Groups can be created for an unlimited number of people. Messages can be accessed from several devices and shared with members of a group or individuals. The multi-data center infrastructure and encryption provide the advantages of speed and security.

In some embodiments, direct communication can be made with a user's phone contacts under the protection and security of a server-to-client encryption layer or a client-to-client encryption layer, even if the contact's number is not known. In other embodiments, contacts with the same messenger application are shown at the top of a user's contacts list. Pictures associated with individual users can also be employed.

When using embodiments described herein, a graphical user interface (GUI) icon can be used to indicate that a message has been sent, and to indicate that the message is on the associated server and is waiting for the recipient to open the message. Another GUI icon can be displayed when the recipient has opened the message.

In an embodiment, the server-to-client encryption layer and the client-to-client encryption layer utilize a 256-bit symmetric encryption and a secure key exchange. However, other encryption bits and key exchanges can also be utilized in embodiments described herein.

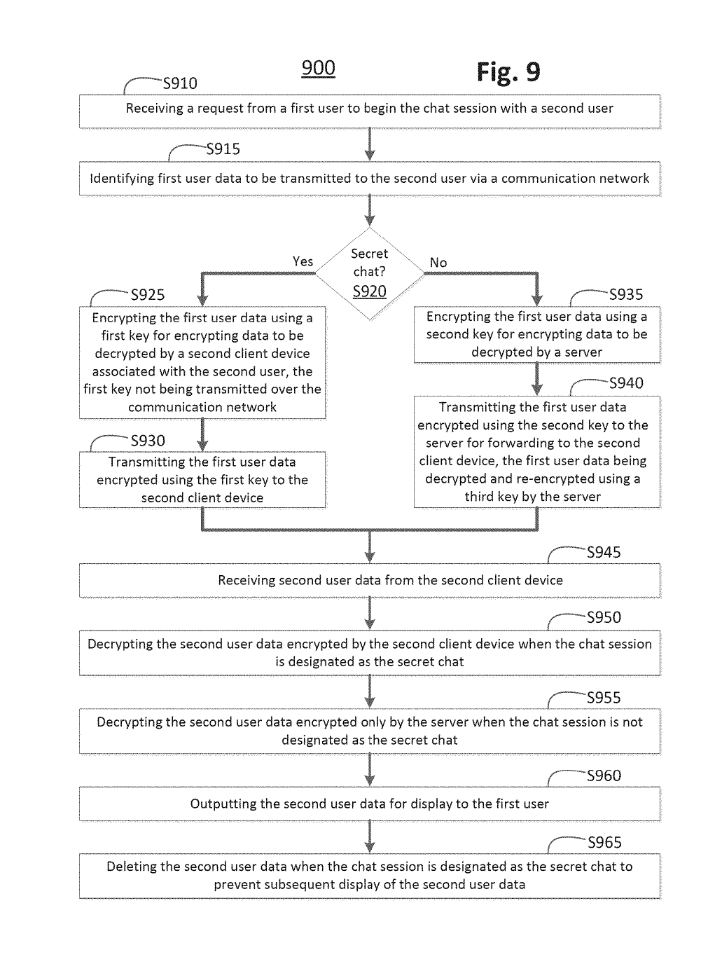

FIG. 9 is an exemplary algorithmic flowchart from a terminal perspective of a method 900 of communicating via a chat session. A non-transitory computer-readable medium storing instructions which, when executed by a computer of a first client device, cause the computer to perform method 900.

In step S910, method 900 includes receiving a request from a first user to begin the chat session with a second user. For example, the first user selects the second user in a chat application. The first user may designate whether the chat is to be designated as a secret chat.

In step S915, first user data to be transmitted, via a communication network to the second user is identified. For example, the first user enters a message or attaches an image to be sent, via the chat session.

In step S920, it is determined whether the requested chat session is designated as a secret chat. The first client device makes this determination based on whether the chat was designated as secret at the time of the initial request or checks attribute information of the chat session.

When the requested chat session is designated as a secret chat (YES in step S920), the first user data is encrypted by circuitry of the first client device in step S925, using a first key for encrypting data to be decrypted by a second client device associated with the second user, wherein the first key is not transmitted over the communication network. The first key may have been previously provided to the second user via the network or other communication methods, such as SMS that are independent of the chat service provider. In another embodiment, information sufficient for the second client device to independently generate the first key is provided.

In step S930, the first user data encrypted using the first key is transmitted to the second client device. The encrypted first user data may be forwarded by a server of the chat service provider in certain embodiments.

When the requested chat session is not designated as a secret chat (NO in step S920), the first user data is encrypted by the circuitry in step S935, using a second key for encrypting data to be decrypted by the server.

In step S940, the first user data encrypted using the second key is transmitted to the server for forwarding to the second client device. The first user data is decrypted and then re-encrypted using a third key by the server.

In step S945, a second user data is received from the second client device. In step S950, the second user data encrypted by the second client device is decrypted by the first client device when the chat session is designated as the secret chat.

In step S955, the second user data encrypted only by the server is decrypted when the chat session is not designated as the secret chat. In step S960, the second user data is outputted for display to the first user.

In step S965, the second user data is deleted when the chat session is designated as the secret chat to prevent subsequent display of the second user data. For example, the second user data is deleted after a predetermined period of time when the chat session is ended or closed, or when one or more other predetermined conditions are met.

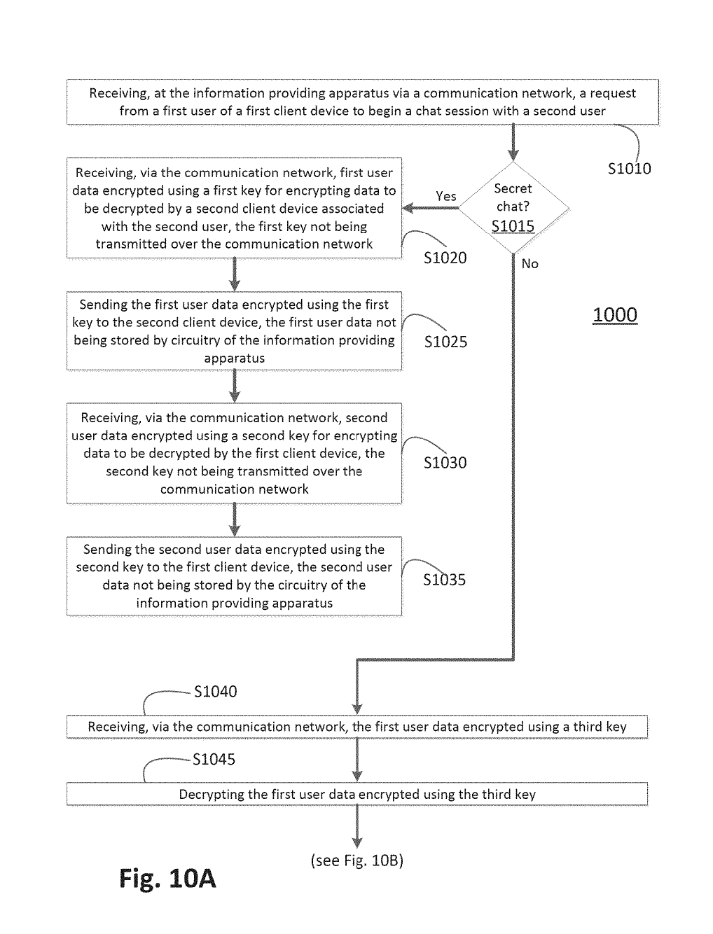

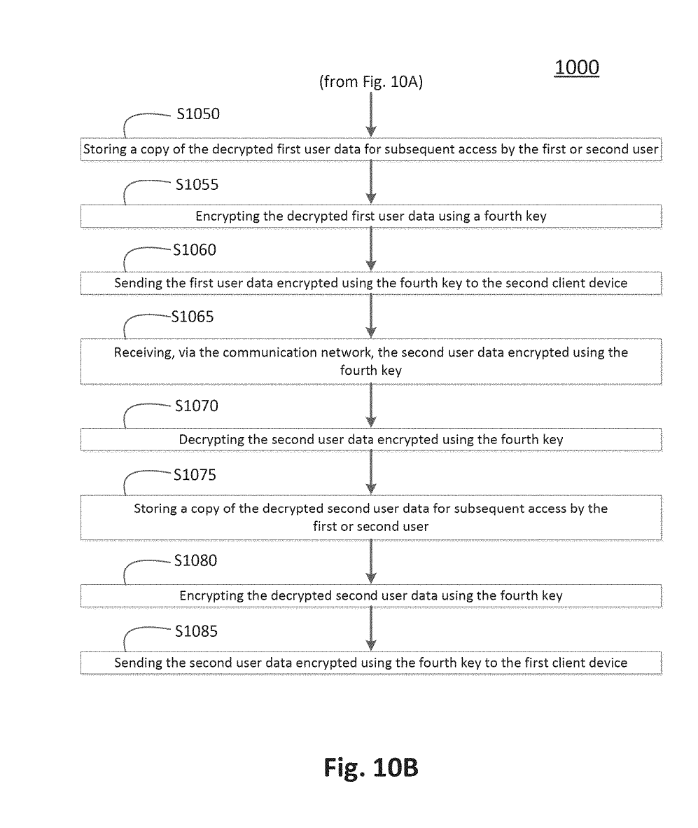

FIGS. 10A-10B are an exemplary algorithmic flowchart for a method 1000 of an information providing apparatus for providing a chat session. In one embodiment, the information providing apparatus is implemented by one or more servers connected to a communication network, such as the Internet. The one or more servers may be configured to provide the chat service.

In step S1010, method 1000 includes receiving, at the information providing apparatus via a communication network, a request from a first user of a first client device to begin the chat session with a second user. In step S1015, it is determined whether the requested chat session is designated as a secret chat.

When the requested chat session is designated as a secret chat (YES in step S1015), method 1000 includes receiving, via the communication network, first user data encrypted using a first key for encrypting data to be decrypted by a second client device associated with the second user in step S1020. The first key is not transmitted over the communication network.

In step S1025, method 1000 includes sending the first user data encrypted using the first key to the second client device, wherein the first user data is not stored by circuitry of the information providing apparatus. In one embodiment, the first user data may be temporarily stored until the first user data is successfully forwarded to the second client device.

In step S1030, method 1000 includes receiving, via the communication network, second user data encrypted using a second key for encrypting data to be decrypted by the first client device. The second key (e.g., similar to the first key) is not transmitted over the communication network. The first and second keys may be the same or different, depending on the embodiment.

In step S1035, method 1000 includes sending the second user data encrypted using the second key to the first client device. The second user data is not stored by the circuitry of the information providing apparatus (e.g. similar to the first user data).

When the requested chat session is not designated as a secret chat (NO in step S1015), method 1000 includes receiving, via the communication network, the first user data encrypted using a third key in step S1040. In step S1045, method 1000 includes decrypting the first user data encrypted using the third key.

In step S1050, method 1000 includes storing a copy of the decrypted first user data for subsequent access by the first or second user. In step S1055, method 1000 includes encrypting the decrypted first user data using a fourth key.

In step S1060, method 1000 includes sending the first user data encrypted using the fourth key to the second client device. In step S1065, method 1000 includes receiving, via the communication network, the second user data encrypted using the fourth key.

In step S1070, method 1000 includes decrypting the second user data encrypted using the fourth key. In step S1075, method 1000 includes storing a copy of the decrypted second user data for subsequent access by the first or second user.

In step S1080, method 1000 includes encrypting the decrypted second user data using the fourth key. In step S1085, method 1000 includes sending the second user data encrypted using the fourth key to the first client device. Further, in certain embodiments, different keys may be utilized to communicate from the client device to the information providing apparatus and from the information providing apparatus to the client device.

An advantage provided by embodiments described herein is a private chat between two or more user devices. All messages in a private chat use end-to-end encryption, which means only the chat session users can read, decipher, or intercept the exchanges. Messages in a private chat cannot be forwarded. In addition, a user can also specify his/her message to be eliminated from his/her own device, as well as the chat session messages from the other users' devices. A timer can be utilized to remove the message(s) after a pre-determined time from the conclusion of the chat session. In certain embodiments, a message may be eliminated or prevented from being displayed based on data acquired from the motion sensor 208, GPS 260, and/or camera 200. For example, a message may be deleted when the motion sensor 208 senses a predetermined change in the orientation or position of a user device (e.g., a motion that suggests the user is attempting to show the screen to another individual), when the GPS 260 indicates that the user device is in a public location or has moved outside a predetermined area, when the camera 200 detects that the user of the user device is no longer in front of or looking at the display, and/or when the camera 200 detects that more than one person is viewing the display of the user device.

Private chat sessions are device-specific. Therefore, a private chat session is only available on the original device for the duration of that session. If the session is logged out, all message content will be lost for that particular private chat session. However, multiple chat sessions can be initiated simultaneously. When a private chat session is created, participating devices can exchange encryption keys, such as a Diffie-Hellman key exchange. Generated images can be confirmed by each participant of the session to further enhance a secure chat session.

If a secure messenger session is desired, but users wish to store or share certain content or attachments of the session, a client-to-server encryption layer can be utilized. Encryption is still maintained, but designated content is stored in the cloud structure and/or forwarded to other users. Embodiments described herein provide a combination of the two types of sessions.

The foregoing discussion discloses and describes merely exemplary embodiments. As will be understood by those skilled in the art, the described embodiments may be embodied in other specific forms without departing from the spirit or essential characteristics thereof. Accordingly, the disclosure is intended to be illustrative, but not limiting of the scope of the claims. The disclosure, including any readily discernible variants of the teachings herein, defines in part, the scope of the foregoing claim terminology such that no inventive subject matter is dedicated to the public.

1. A non-transitory computer-readable medium storing instructions which when executed by a computer of a first client device cause the computer to perform a method of communicating via a chat session, the method comprising:
receiving a request from a first user to begin the chat session with a second user;
identifying first user data to be transmitted to the second user via a communication network;
when the requested chat session is designated as a secret chat,
encrypting, by circuitry of the first client device, the first user data using a first key for encrypting data to be decrypted by a second client device associated with the second user, the first key not being transmitted over the communication network, and
transmitting the first user data encrypted using the first key to the second client device;
when the requested chat session is not designated as the secret chat,
encrypting, by the circuitry, the first user data using a second key for encrypting data to be decrypted by a server, and
transmitting the first user data encrypted using the second key to the server for forwarding to the second client device, the first user data being decrypted and re-encrypted using a third key by the server;
receiving second user data from the second client device;
decrypting the second user data encrypted by the second client device when the chat session is designated as the secret chat;
decrypting the second user data encrypted only by the server when the chat session is not designated as the secret chat;
outputting the second user data for display to the first user; and
deleting the second user data when the chat session is designated as the secret chat to prevent subsequent display of the second user data.

2. The non-transitory computer-readable medium of claim 1, wherein the method further comprises:
generating the first key based on information received from the second client device.

3. The non-transitory computer-readable medium of claim 1, wherein the method further comprises:
prohibiting at least one predetermined user operation of the first client device when the chat session is the secret chat.

4. The non-transitory computer-readable medium of claim 1, wherein the method further comprises:
prohibiting a screen capture operation and copying of the received second user data or the received second user data and the first user data when the chat session is the secret chat.

5. The non-transitory computer-readable medium of claim 4, wherein the step of prohibiting further comprises:
prohibiting the screen capture operation and the copying of only the received second user data.

6. The non-transitory computer-readable medium of claim 1, wherein the step of transmitting the first user data encrypted using the first key comprises:
transmitting the first user data encrypted using the first key to the second client device via the server.

7. The non-transitory computer-readable medium of claim 1, wherein the step of transmitting the first user data encrypted using the first key comprises:
transmitting different portions of the first user data encrypted using the first key to the second client device via different servers.

8. The non-transitory computer-readable medium of claim 1, wherein the second user data is encrypted by the second client device using the first key.

9. The non-transitory computer-readable medium of claim 1, wherein
the received second user data is encrypted by the second client device and further encrypted by the server, and
the method further includes decrypting the second user data encrypted by the server to obtain the second user data encrypted by the second client device.

10. An information providing apparatus, comprising:
circuitry configured to
receive, via a communication network, a request from a first user of a first client device to begin a chat session with a second user;
when the requested chat session is designated as a secret chat,
receive, via the communication network, first user data encrypted using a first key for encrypting data to be decrypted by a second client device associated with the second user, the first key not being transmitted over the communication network,
send the first user data encrypted using the first key to the second client device, the first user data not being stored by the circuitry,
receive, via the communication network, second user data encrypted using a second key for encrypting data to be decrypted by the first client device, the second key not being transmitted over the communication network, and
send the second user data encrypted using the second key to the first client device, the second user data not being stored by the circuitry; and
when the requested chat session is not designated as the secret chat,
receive, via the communication network, the first user data encrypted using a third key,
decrypt the first user data encrypted using the third key,
store a copy of the decrypted first user data for subsequent access by the first or second user,
encrypt the decrypted first user data using a fourth key,
send the first user data encrypted using the fourth key to the second client device;
receive, via the communication network, the second user data encrypted using the fourth key,
decrypt the second user data encrypted using the fourth key,
store a copy of the decrypted second user data for subsequent access by the first or second user,
encrypt the decrypted second user data using the fourth key, and
send the second user data encrypted using the fourth key to the first client device.

11. The information providing apparatus of claim 10, wherein the first key is generated by the first client device based on information received from the second client device.

12. The information providing apparatus of claim 10, wherein at least one predetermined user operation of the first client device and the second client device is prohibited when the chat session is the secret chat.

13. The information providing apparatus of claim 10, wherein a screen capture operation and copying of the received second user data or the received second user data and the first user data is prohibited in the first or second client device when the chat session is the secret chat.

14. The information providing apparatus of claim 13, wherein the screen capture operation and the copying of only the received second user data is prohibited in the first client device when the chat session is the secret chat.

15. The information providing apparatus of claim 10, wherein the circuitry is further configured to
provide to the first client device a saved chat session with the second user when the requested chat session is not designated as the secret chat.

16. The information providing apparatus of claim 10, wherein different portions of the first user data encrypted using the first key are transmitted to the second client device via different servers.

17. The information providing apparatus of claim 10, wherein the first key and the second key are the same.

18. The information providing apparatus of claim 10, wherein the circuitry is further configured to
encrypt the first user data encrypted using the first key that is sent to the second client device using the fourth key, and
encrypt the second user data encrypted using the second key that is sent to the first client device using the third key.

19. The information providing apparatus of claim 10, wherein the first and second keys are not known to the information providing apparatus.

20. A method of an information providing apparatus for providing a chat session, the method comprising:
receiving, at the information providing apparatus via a communication network, a request from a first user of a first client device to begin the chat session with a second user;
when the requested chat session is designated as a secret chat,
receiving, via the communication network, first user data encrypted using a first key for encrypting data to be decrypted by a second client device associated with the second user, the first key not being transmitted over the communication network,
sending the first user data encrypted using the first key to the second client device, the first user data not being stored by circuitry of the information providing apparatus,
receiving, via the communication network, second user data encrypted using a second key for encrypting data to be decrypted by the first client device, the second key not being transmitted over the communication network, and
sending the second user data encrypted using the second key to the first client device, the second user data not being stored by the circuitry of the information providing apparatus; and
when the requested chat session is not designated as the secret chat,
receiving, via the communication network, the first user data encrypted using a third key,
decrypting the first user data encrypted using the third key,
storing a copy of the decrypted first user data for subsequent access by the first or second user,
encrypting the decrypted first user data using a fourth key,
sending the first user data encrypted using the fourth key to the second client device;
receiving, via the communication network, the second user data encrypted using the fourth key,
decrypting the second user data encrypted using the fourth key,
storing a copy of the decrypted second user data for subsequent access by the first or second user,
encrypting the decrypted second user data using the fourth key, and
sending the second user data encrypted using the fourth key to the first client device.
